(19) United States
(12) Patent Application Publication
(10) Pub. No.: US 2012/0060123 A1
(43) Pub. Date: Mar. 8, 2012

(54) Systems and methods for deterministic control of instant-on mobile devices with touch screens

(76) Inventor: Hugh Smith, San Luis Obispo, CA (US)

(21) Appl. No.: 13/222,337

(22) Filed: Aug. 31, 2011

Related U.S. Application Data
(60) Provisional application No. 61/380,001, filed on Sep. 3, 2010.

(51) Int. Cl. G06F 3/048

(52) U.S. Cl. 715/833; 715/810

(57) ABSTRACT

A new approach is proposed that contemplates systems and methods to overcome the limitations described above in order to provide a user with a more deterministic experience when using his/her touch screen-enables instant-on device such as a smartphone. More specifically, the user is provided with a lock menu screen via an application, which displays a menu of a plurality of applications that can be run on his/her phone when the user unlocks/wakes up the phone. Since the user typically uses only a limited number of applications most of the time, the lock menu application allows the user to specify these applications and then provides them quick access to these applications. This not only provides the user with a deterministic experience by allowing them quick access to their most important applications when the phone wakes up, but also allows the user to return to the application that was running prior to the phone going to sleep if the user desires.

### RELATED APPLICATIONS

This application claims the benefit of U.S. Provisional Patent Application No. 61/380,001, filed Sep. 3, 2010, entitled “Systems and methods for deterministic control of smart phones,” and is hereby incorporated herein by reference.

### BACKGROUND

A typical usage of a touch screen based instant-on smartphone or tablet such and the Motorola Droid, Motorola Droid X, HTC Hero, Apple iPad or the Apple iPhone can be described as follows. When the device is asleep the user pushes a button which waked up the device and displays the lockscreen, which is sometimes referred to as the keyguard. The user then slides a slider and the user is taken to either an already running applications left on the run queue or to one of the device's home desktops (sometimes referred to as home screens). The use of a lockscreen on a instant-on mobile device having a touch screen protects the user from running things by mistake when, for a non-limiting example, the smartphone in the user pocket is bumped and performs certain operations not intended by the user.

Phones running Android 2.2 have at least five desktops, each desktop displays icons for applications and allows the user to select which applications to run. When an application is run it is placed on the run queue which tracks running applications. If the user does not end this application prior to the device going to sleep, when the device is woken and the lockscreen slider is activated the application on the top of the run queue will be run. For the user to access other applications they need to return to the desktop (by either ending the application) or use a back or home button (either physical or a logical button). Even after they get to the desktop they may need to move around the multiple desktops in order to find the application they wish to run. To make a call or check their email the user must take multiple steps and these steps will vary depending on the state the phone was last in.

Some of the problems associated with this experience are that it is inflexible and non-deterministic. After starting up the device the user will be put into whatever they were doing before the last time the phone went to sleep and require multiple and varying steps to get to an application. In addition, the user typically will run a few applications most of the time. The current configuration does not give a quick and easy way to access these applications. Additionally, unlike laptop users, smartphone users may be using these devices while actually doing something else, such as sitting behind the wheel driving. The non-deterministic behavior of current devices makes it very difficult for the user to navigate screens in order to find the correct application under such real world circumstances.

A limitation on slider based smartphones is a limited screen space for buttons and the cost of adding more buttons. The screen is typically maximized for display of content leaving little room for other buttons or other features on the phones visual display surface. While fold-out keyboards are possible they would require additional steps by the user and would be cumbersome to use for quick application access.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 shows an example of the default lock screen running on a phone.

FIG. 2 depicts an example of the lock menu screen provided by the lock menu application running on the phone.

FIG. 3 depicts an example of one of the settings menus for the lock menu application.

FIGS. 4 A-C depict examples of screenshots directly from an Android phone.

FIG. 5 depicts an alternative way to configure the lock menu screen.

FIG. 6 depicts an example of a listing of the Java classes used to implement the lock menu application.

FIG. 7 depicts an example of a state diagram that presents the configurability and deterministic implementation of the lock menu application.

FIG. 8 depicts an example of a flowchart of a process to show how a user selects from the lock menu screen when the lock menu application is executed.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to overcome the limitations described above in order to provide a user with a more deterministic experience when using his/her touch screen-enabled instant-on mobile device such as a smartphone or tablet. More specifically, the user is provided with a lock menu screen, which displays a menu of a plurality of applications that can be run on his/her phone when the user unlocks/wakes up the device. This lock menu screen includes at least one slider to access an application and may further include a number of sliders or a combination of sliders and icons. Since the user typically uses only a limited number of applications most of the time, the lock menu application allows the user to specify these applications and then provides them quick access to these applications. This not only provides the user with a deterministic experience by allowing them direct and quick access to their most important applications when the phone wakes up, but also allows the user to return to the application that was running prior to the phone going to sleep if the user desires.

In some embodiments, the lock menu application also controls the terminating behavior of the program and allows the user to configure the options when a user leaves/terminates an application. This provides the user with a more deterministic experience and enables the user to control the run-queue of the applications running on the phone in order to allow the user to specify the flow of control once an application terminates, such as via the home key, back key or the phone going to sleep. As would be obvious to one skilled in the art the lock menu application may be a single application or the application could consist of a number of applications and/or components working together to provide this functionality.

The proposed approach is enabled and implemented via a user interface engine (not shown). As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions are loaded into memory (also referred to as primary memory) by a processor. The processor then executes the software instructions in memory. The processor may be a shared processor, a dedicated processor, or a combination of shared or dedicated processors. These instant-on devices typically use some type of flash memory. A typical program will include calls to hardware components (such as I/O devices), which typically requires the execution of drivers. The drivers may or may not be considered part of the engine, but the distinction is not critical.

In some embodiments, the user interface engine runs on a mobile host device (host) having a touch screen, which is an electronic visual display that can detect the presence and location of a touch within a display area. In addition to the touch screen, these hosts are usually instant-on devices where the user is provided with easy and quick access to their applications when the device is turned-on or woken up. Here, the instant-on host with a touch screen can be a computing device, a communication device, a storage device, or any electronic device capable of running a software component. For non-limiting examples, the host can be but is not limited to a tablet, an iPod, an iPhone, an iPad, Google's Android phone, tablet or device, and other type of smartphone. Although an Android phone is used as an example in the following discussion, it is well known to one skilled in the art that similar approaches are also applicable to other non Android-based host devices.

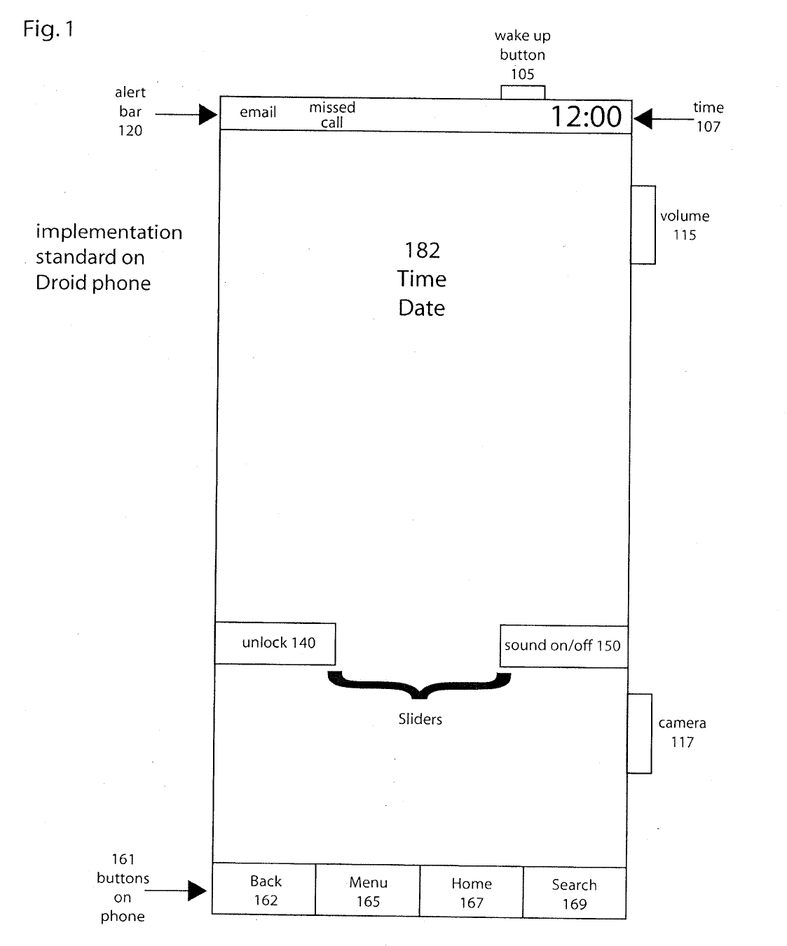

FIG. 1 shows an example of the default lock screen running on, for a non-limiting example, the Motorola Droid phone running Android 2.2. This lockscreen is brought up on the touch screen of the phone when the user wakes up the phone by depressing the wakeup button 105 on the top of the phone. This lockscreen provides for two options either to “Unlock” the phone via slider 140 or turn the sound on or off via slider 150. All other options are usually disabled. This includes the buttons on the bottom of the phone (e.g., back 162, menu 165, home 167, and search 169) are and the volume 115 and camera buttons 117 on the side of the phone. Although the alert bar 120 is displayed, it is disabled. Once the user slides the slider 140 to unlock the phone the phone then goes to the last application that was run on the phone (top of the run queue) or to the Android desktop.

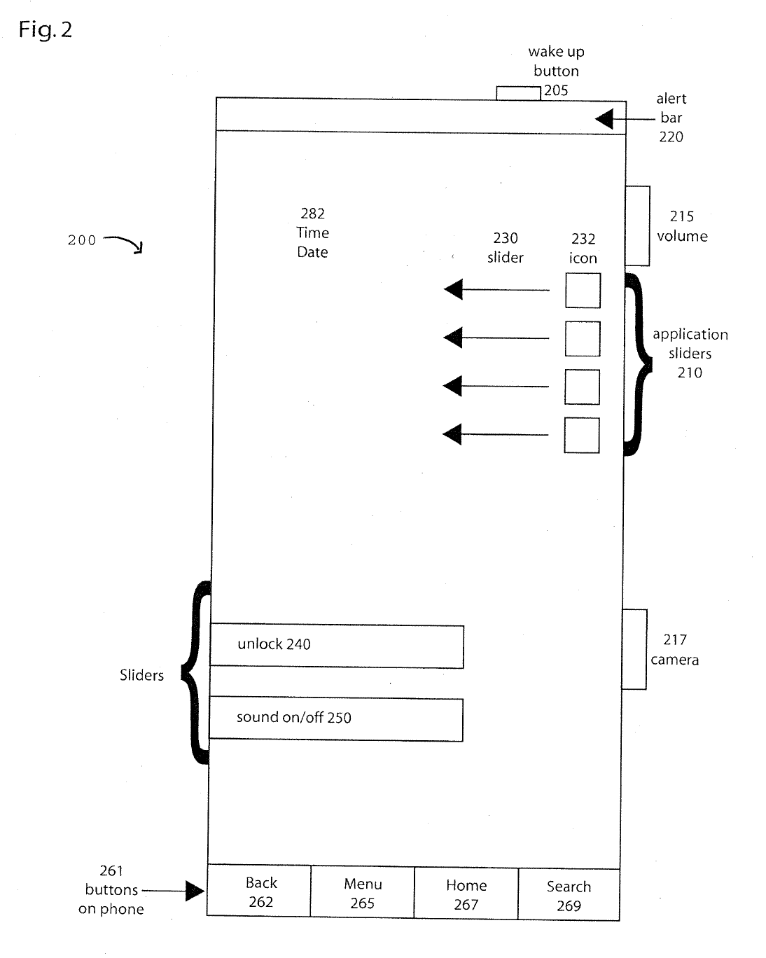

FIG. 2 depicts an example of the lock menu screen 200 provided by the lock menu application running on the phone. Here, the lock menu application provided by the user interface engine enables the user to configure a variable number of user applications to be present on the lock menu screen 200. In FIG. 2, these applications 210 can be selected and activated by the user using sliders 230 with icons 232. The number of applications is a configuration option but it has been found that between 4 and 6 sliders fits well on current smartphone screens. In addition to the application sliders, the lock menu screen 200 enables the user to unlock the phone via slider 240 or turn the sound on or off via slider 250. Also displayed on the lock menu screen 200 is the alert bar 220 and the date and time 282. While the lock menu application enables the user to select applications using sliders as described above, it is well known to one skilled in the art that the same approach can be implemented using either a slider or icon based interface. As discussed below, the lock menu application can manage the run queue of the applications running on the phone via either interface to provide a deterministic experience.

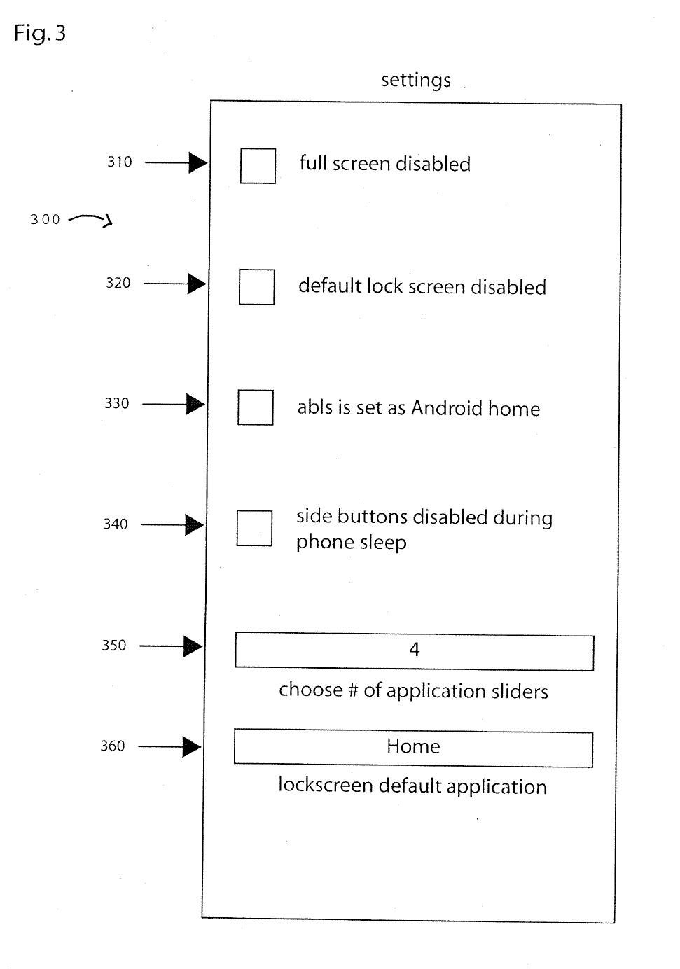

There are various configuration options for this type of application. FIG. 3 depicts an example of one of the settings menus for the lock menu application enabled by the user interface engine, wherein the setting screen/menu 300 may be reached via the menu button when the lock menu screen is displayed or via the alert bar 220. In some embodiments, this setting screen 300 has four checkboxes (310, 320, 330, and 340) and two pull down menus (e.g., 350 and 360). This first checkbox 310 enables the user to set the lock menu to take over the entire screen when the lock menu screen is displayed. This effectively eliminates the standard alert bar from being displayed on the lock menu. The next checkbox 320 enables the user to turn on or off the default display of the lock menu on the screen. It is possible for security reasons that a user may wish the Android or other lockscreen be displayed first and then the lock menu screen and checkbox 320 allows the user to enforce some type of security such as requiring a specific pattern, pin, or password to be used to allow access to the phone via a security screen. Checkbox 330 provides the user with the ability to configure the default terminating behavior of user applications after they have been run by the lock menu application. This option allows the user to either return directly to the lock menu screen when a user application terminates or return to the desktop of the phone.

In some embodiments, the lock menu application supports a variable number of user applications on the lock menu screen 200. For a non-limiting example, the lock menu application as shown in FIG. 2 supports between 4 and 6 different user applications. Pull down menu 350 enables the user to modify this setting. Pull down menu 360 allows the user to configure which application is running when the user unlocks the phone. Note that some phone manufacturers provide a different desktop home application than the standard Android home application as shown and the pull down menu 360 enables the user to configure a different default home application to use when the phone is unlocked.

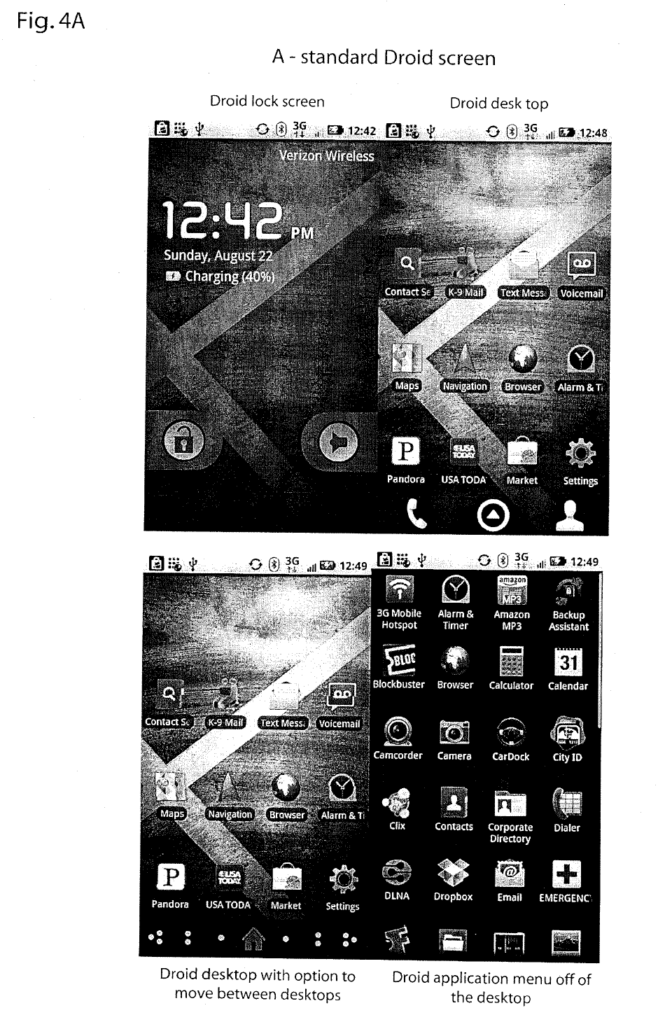

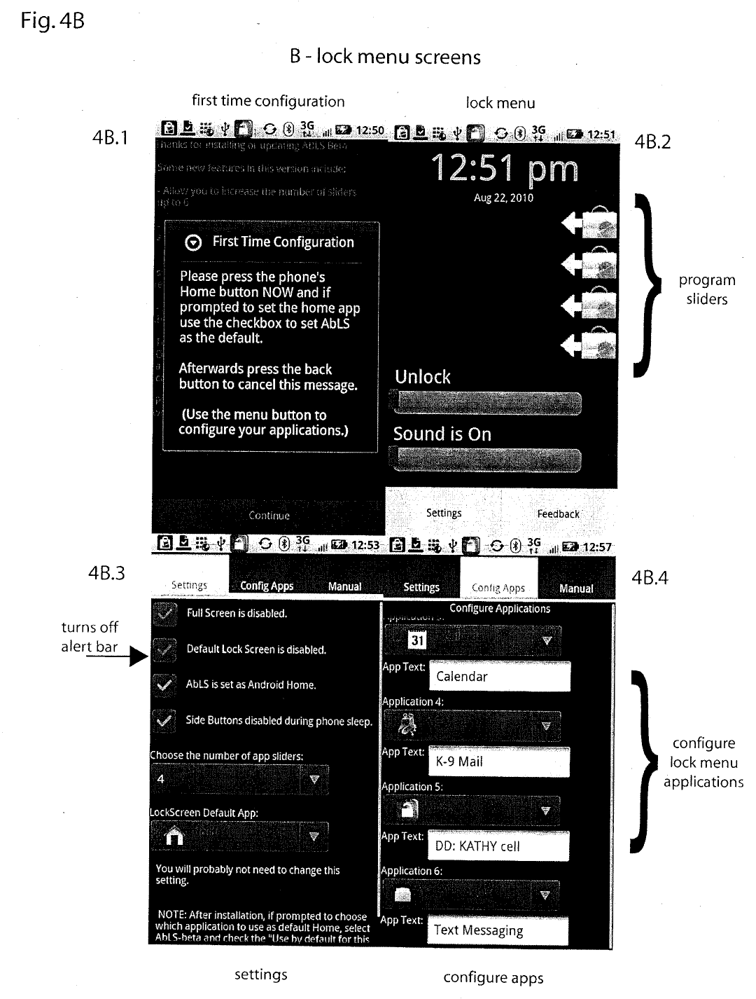

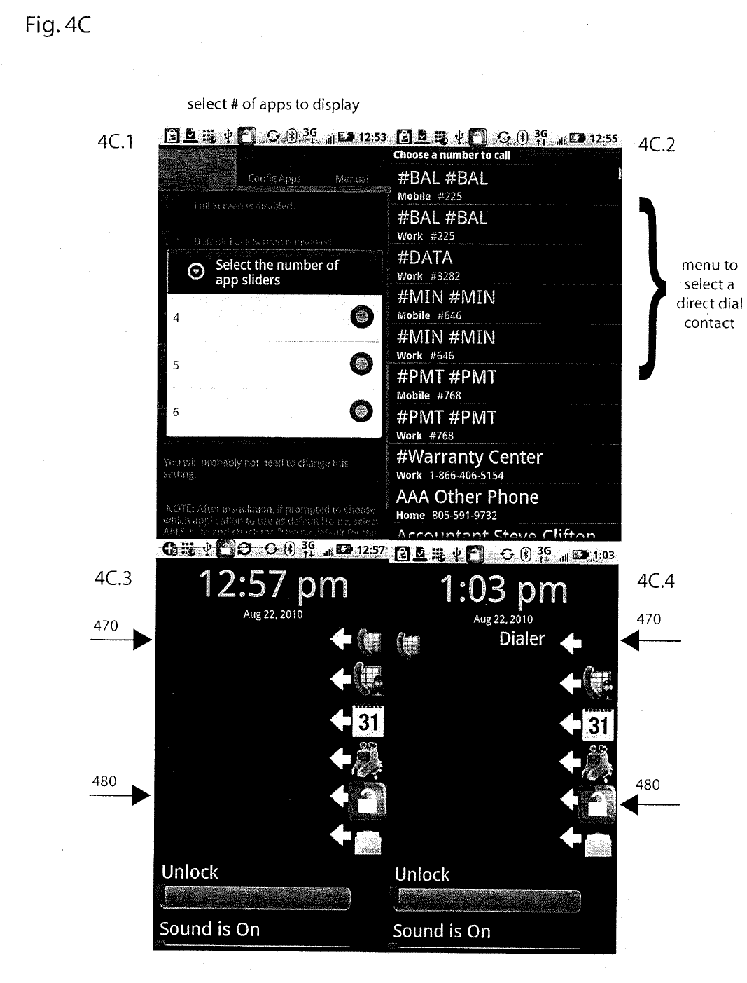

FIGS. 4 A-C depict examples of screenshots directly from a Motorola Droid phone running Android version 2.2. FIG. 4A shows four screen shots of the phone running strictly the standard Android lock screen interface and desktop application. As stated earlier this interface does not provide the user with any options when they wake up their phone, nor does it provide a deterministic experience for the user.

FIGS. 4B and 4C show examples of a number of screenshots of the lock menu application enabled by the user interface engine. More specifically, FIG. 4B.1 shows the first time lock menu screen display, where when the user first runs the lock menu application they may be prompted by the phone to set their home application. For the lock menu application to work correctly, this setting needs to be configured to use the lock menu application as the home application. FIG. 4B.2 shows the default lock menu when the lock menu application is first run. Here, the lock menu screen defaults to four sliders. FIG. 4B.3 shows the setting menu as discussed in FIG. 3. FIG. 4B.4 shows the application configuration screen, which enables the user to pick an application to add to the lock menu screen using drop down menus. When one of the applications is selected, a drop down menu of all the user applications is displayed and the user is allowed to select the desired application. The default icon to be displayed on the lock menu screen for that application is also assigned. In addition, the user is enabled by the user interface engine to specify the text that will be displayed with that application, where the default text is the application name.

FIG. 4C.1 shows the user using the “Choose the number of app sliders” in order to select the number of applications to display on the lock menu. In some embodiments, one of the application options provided by the lock menu application is to setup a “special application” such as setting one of the applications on the lock menu to a direct dial number. The user may do this by long selecting (holding down the application name) and the lock menu application will create a direct dial number special application. To facilitate this, a menu of the user's contacts is displayed and the user may select one contact from the menu. FIG. 4C.2 shows the list of the user's contacts in order to allow them to set up the direct dial lock menu “application”. The default text for a direct dial number is the contacts name, which means that when this “application” is chosen from the lock menu screen a phone number will be immediately dialed. FIGS. 4C.3 and 4C.4 show a fully configured lock menu screen. More specifically, FIG. 4C.3 is an example of the lock menu screen configured to run 6 different applications, including but not limited to, the dialer application 470, contacts application, calendar, email, a direct dial 480 and text messaging. FIG. 4C.4 shows slider 470 being used to enable the dialer application.

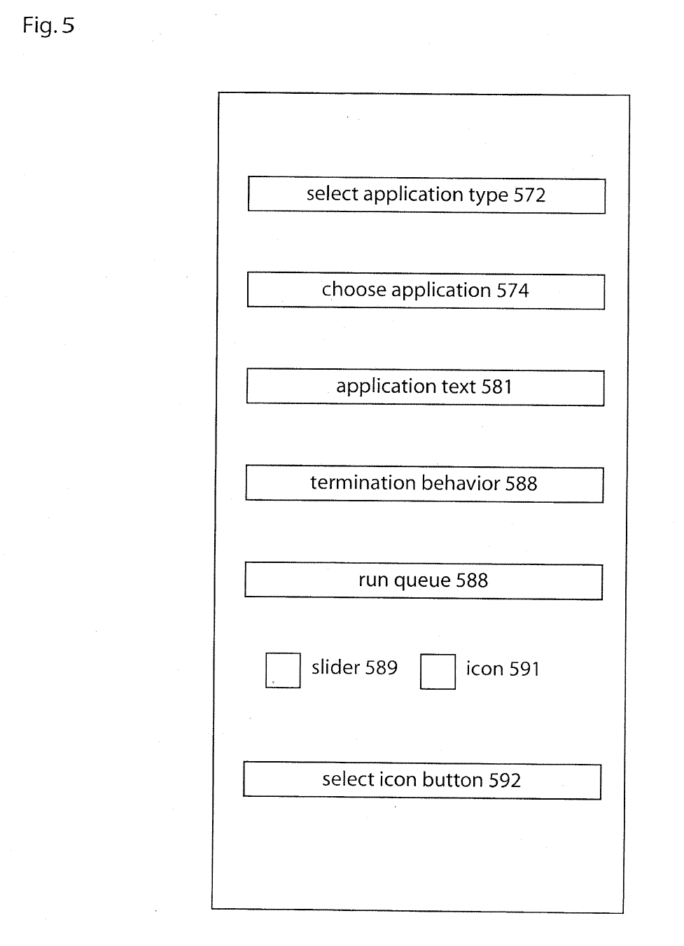

FIG. 5 depicts an alternative way to configure the lock menu screen enabled by the user interface engine. Here, screen 500 provides the user with more control over how the application(s) are displayed on the lock menu screen, the type of application (e.g. a special application, as discussed below, or a normal application), how the termination of the application is handled and whether the application should remain on the run queue after the application terminates. As shown in FIG. 5, Box 572 allows the user to specify the type of the application on the lock menu. Options include but are not limited to, running a normal application, setting up a direct dial number, setting up a quick call page, or going directly to Android home. Box 574 is a drop down menu that allows the user to select the application to run. After selecting the application the user may configure multiple options for that application. Options for a normal application include but are not limited to, specifying the text that will be displayed with the application (Box 581), pull down menu to select the ending behavior (Box 588) should the application remain on the run queue or not, pull down menu to select where the application returns after termination (Box 586), which includes run another application, return to the Lock menu screen, go to the android home application, check box to select the use of either a slider (Box 589) or icon (Box 591) for this application on the lock menu screen and a button to allow the user to select what icon should be displayed for this application, wherein touching of this button will bring up a screen of icons and allow the user to select one of them. While not shown, setting up a direct dial number or quick call page is similar to the process described earlier when discussing setting up a direct dial number as shown in FIG. 4B.4 and FIG. 4C.2. A quick call page provides a listing of names and numbers such that when a user picks from this list the number is immediately called. While a direct dial number is accessed in one step, immediately from the lock menu screen, the quick call list requires the user to select this option from the Lock menu and then select the number to call. For the quick call numbers a list of numbers (with names and type of number e.g. home, mobile) is maintained in an array and this array is displayed when the user selects this special application from the lock menu screen. To create this list, lock menu application presents the user with a listing of their contacts and is able to select a number and configure the name to be displayed. The number of names on the quick call list is also configurable.

In some embodiments, if the user selects to run another application when an application/program terminates via Box 586, a screen similar to FIG. 5 (without the icon/slider checkbox or icon button) can be displayed, which allows the user to select the application to be run next on the host device. When this option is invoked from the lock menu screen, the lock menu application will run the second application after the first application terminates.

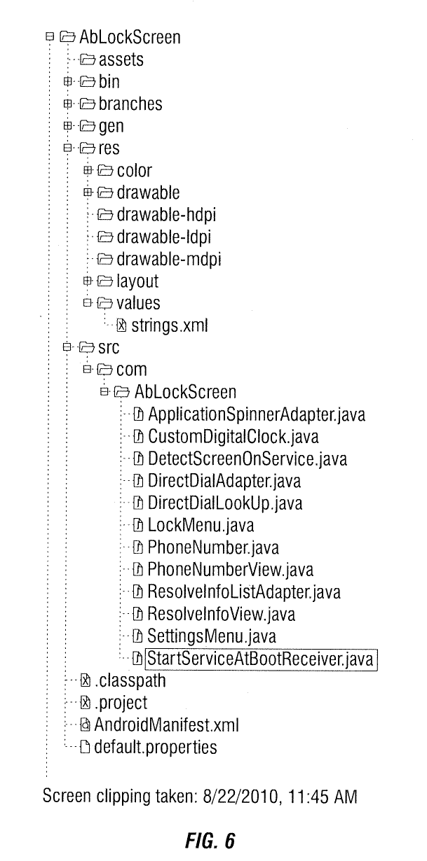

In some embodiments, the lock menu application enabled by the user interface engine can be written using Java using the Eclipse development environment. This environment supports the Android Software Development Kit (SDK) and Android Virtual Device (ADV) which are used to develop Android applications. Our implementation uses a number of java classes. FIG. 6 depicts an example of a listing of the Java classes used to implement the lock menu application.

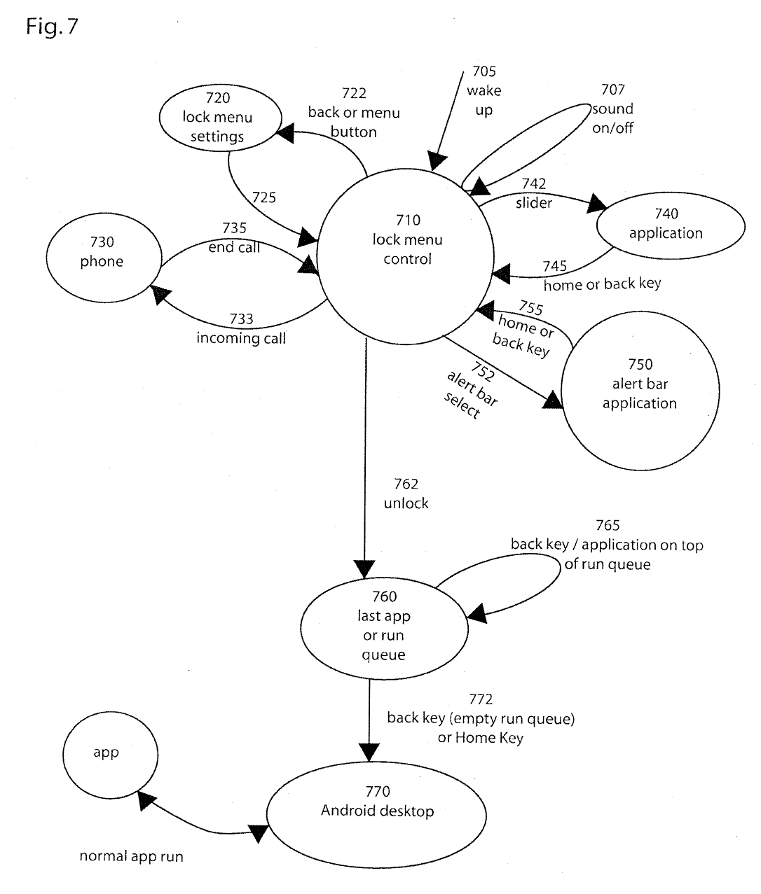

FIG. 7 depicts an example of a state diagram that presents the configurability and deterministic implementation of the lock menu application enabled by the user interface engine. In order for the lock menu application to take control of the phone, it must first be set as the home application of the phone as shown in FIG. 4B.1. Assuming the lock menu application is set as the home application, FIG. 7 shows the phone in the state of main lock menu control 710, wherein control of terminating applications pass through the lock menu application. Therefore, when an application terminates, the lock menu application determines if it is in state 710, and if so the application displays the lock menu screen. If the lock menu application has moved into states 760 or 770, then control is passed back to the normal control of the phone.

The arrows leading out of 710 are interrupts generated either by the phone or the user. For non-limiting examples, if an incoming call is detected (733), the phone application will take over. Once the user hangs up the phone and ends the phone application (735), the user will be returned to the lock menu screen (710). If the user slides the sound on/off slider (705), the lock menu screen will continue to be displayed but the “Sound is On” label will be changed to “Sound is Off” on the lock menu (710). When the user chooses an application (740 via 742) from the lock menu screen, the application will be run but after the application terminates (745), the lock menu screen (710) will be displayed. One configuration option when running an application is to specify whether the application should remain on the run queue after it terminates or if the application should remove itself from the run queue. If left on the run queue control will still be passed to the lock menu control (710) but the application will be reentered when the user unlocks their phone. In an alternative embodiment, when running application 740 and the application ends or the home key or back key is pressed, control is passed directly to the last application on the run queue (760) or the device's desktop (770).

In some embodiments, if the phone is put to sleep (e.g., via button 205) or goes to sleep, the lock menu application checks to see if the side buttons (volume 215 and camera 217) should be disabled. If so, the phone's lock screen application is run to disable these buttons. In either case the lock menu control is configured to take over when the phone wakes up. Upon waking up the phone (705), the lock menu control (710) is run. If the user unlocks the phone (slider 240), control is passed to the application on the top of the run queue (760 via 762). If the run queue is empty, the user will be taken to the last displayed desktop (770). Assuming the run queue was not empty, the application on top of the run queue will be displayed to the user. While running this application, if the user hits the back button (263) and the run queue is empty or the user hits the home button (267), the user will be taken to the last displayed desktop (770). From the desktop the user may move around the desktops or run other applications installed on the phone. Once the phone is put to sleep or goes to sleep, upon waking up the lock menu screen (710) is run.

While not shown in FIG. 7, it should be noted that the terminating behavior of applications run off of the lock menu screen may be configured to not return control to the lock menu but run another application or return control to either the home application of the phone or another application. Such control of the flow is possible since the lock menu application is always given control when a program terminates.

While the default flow of control when using the lock menu application is to pass back control to the lock menu screen when a user terminates an application that had been run from the lock menu screen, this is not the only possible flow of control. The lock menu application allows the user to configure how the flow of control is handled for each application. For non-limiting examples, the user may specify that upon termination of the program, control is passed back to the lock menu screen or to the user's desktop. In addition, the user may specify if the application should be left on the run queue so that the next time the phone is unlocked the application will be displayed. The user may also configure the flow control for a terminating application to run another application prior to returning to the lock menu screen, which allows the user to string together a number of applications to meet their needs.

In some embodiments, the user may configure the phone to run an Android or other lock screen prior to displaying the lock menu screen. This may be desirable in order to allow the user to utilize a security lock screen requiring some type of password or other lockout mechanism or just to provide additional protection to prevent against inadvertently running applications. Even when the lock menu utilizes sliders to activate applications, some users may inadvertently wake up their device and slide an application when removing the device from a pocket or purse. An additional lock screen helps to alleviate this problem.

In some embodiments, the lock menu application provides another option to allow the user to set up one or more special applications. These are applications that perform a specific function or run an application in a specific way. While a special application may be shown on the lock menu screen as a normal icon or slider, they perform a different function than standard user application. For a non-limiting example, the lock menu application allows the user to configure a special application as a direct dial number. In this way the user may call someone with one action directly from the lock menu screen.

In some embodiments, the lock menu application provides a special application which allows the user to go directly to the main desktop from the lock menu screen, bypassing the current run queue. Unlike the unlock functionality (e.g., 240), which takes the user to the most recent running application or most recent desktop, this special application (home application) takes the user directly to the main desktop. This special application may sit in a spot normally used by a normal application slider/icon, the home application may also be configured to sit directly above the unlock slider. This gives the user a deterministic way to access to move around the phone.

In some embodiments, the lock menu application also provides the user with access to frequently dialed numbers via a quick call list. The user is able to configure a set of numbers and then specify a special application icon/slider to go to display this list. When used from the lock menu screen, this special application allows the user to view the set of names with phone numbers and touch one of them to initiate a call. This allows the user quick access, potentially as few as two screen actions, to a group of numbers. Note that this list of special application is not exhaustive. The common feature of these special applications is to simplify the user's ability to quickly access a limited number of features. While there are thousands of applications available for smartphone and many of these applications have a large number of features, users typically need quick access to a small subset of this functionality. These specially configured applications provide direct access to the features most useful to the user.

In some embodiments, the lock menu screen may also display alerts such as calendar, email, missed call or voice mail alerts. These alerts may be displayed on the alert bar or the elsewhere on the lock menu screen. In addition to visual alerts the lock menu application may also be configured to allow the user to have audio alerts for these types of events.

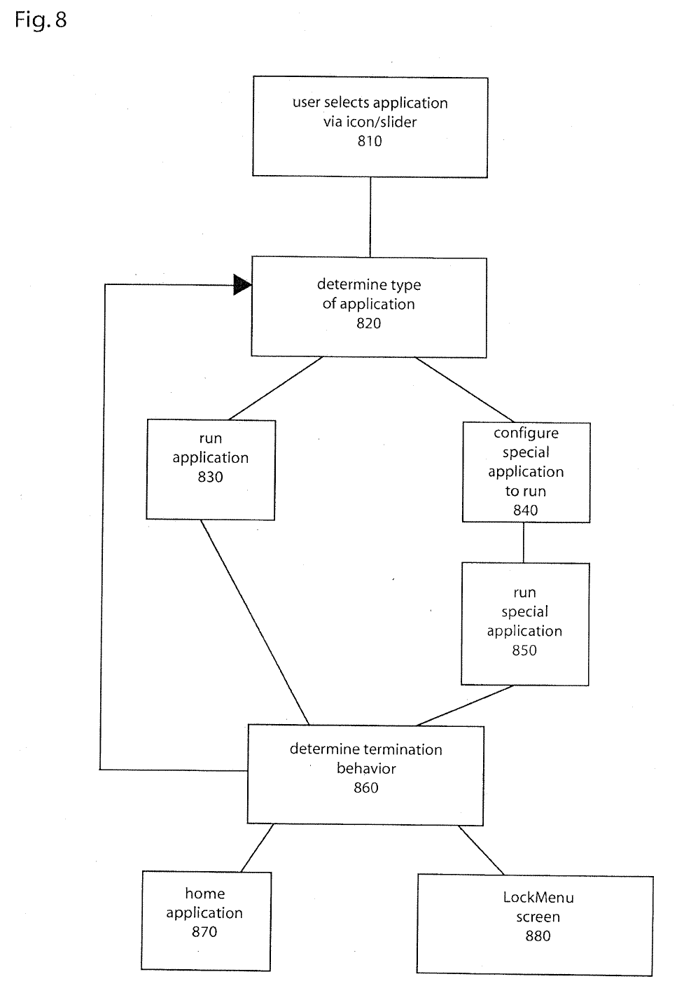

FIG. 8 depicts an example of a flowchart of a process to show how a user selects from the lock menu screen when the lock menu application is executed. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 8, the flowchart 800 starts at block 810 where the user is enabled to select the application from the lock menu screen. Once this application is selected, the flowchart 800 continues to block 820 where the lock menu screen application determines if the selection is a normal application or a special application. During this step, the option to remove the application from the run queue upon termination is specified. If it is a normal application, the flowchart 800 continues to block 830 where the lock menu screen application will run the program. If the application is a special application, the flowchart 800 continues to block 840 where the configuration parameters (such as the direct dial number or a number from the quick call list) are determined and then the flowchart 800 continues to block 850 where the correct application is run. The flowchart 800 continues to block 860 where the termination behavior is determined following the termination of the application. Finally, the flowchart 800 ends at block 870 where the user is sent back to/presented with the home application of the phone or at block 880 where the user is returned to the lock menu screen. Alternatively, in the case of linked applications (an application set to run after the first application, terminates) the flowchart 800 returns to block 820.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system for providing a user with deterministic control over a mobile instant-on host device having a touch screen that instantly runs applications for the user to access when the device is turned-on or woken-up, comprising:
a user interface engine running on the host device, which in operation,
provides the user with a lock menu application that displays on the touch screen a lock menu of a plurality of applications that can be run on the host device when the user wakes up the host device;
enables the user to select one or more of the plurality of applications from the menu using a slider; and
runs the selected one or more applications on the host device.

2. The system of claim 1, wherein:
the host device is one of an iPod, an iPhone, an iPad, an Android phone or device, and other type of smartphone.

3. The system of claim 1, wherein:
the lock menu application
determines termination behavior of the selected one or more applications and
allows the user to configure the options when the selected one or more applications terminate.

4. The system of claim 1, wherein:
the lock menu application enables the user to specify the plurality of applications on the menu.

5. The system of claim 1, wherein:
the lock menu application enables the user to select the one or more of the plurality of applications via a plurality of sliders.

6. The system of claim 1, wherein:
in addition to the one or more sliders the lock menu application enables the user to select the one or more of a plurality of applications via icons.

7. The system of claim 1, wherein:
the lock menu application enables the user to set the lock menu to take over the entire touch screen when the lock menu screen is displayed and eliminate the standard alert bar from being displayed on the lock menu.

8. The system of claim 1, wherein:
the lock menu application enables the user to turn off display of the lock menu on the touch screen.

9. The system of claim 1, wherein:
the lock menu application enables the user to configure number of the plurality of applications on the menu.

10. The system of claim 1, wherein:
the lock menu application enables the user to configure which application is running when the user unlocks the host device.

11. The system of claim 1, wherein:
the lock menu application enables the user to set one of the application on lock menu to a direct dial number.

12. The system of claim 1, wherein:
the lock menu application enables the user to select the application to run next after the one or more applications terminate.

13. The system of claim 1, wherein:
the lock menu application enables the user to configure to return to the lock menu after the one or more applications terminate.

14. The system of claim 1, wherein:
the lock menu application enables the user to configure to return to default screen display of the host device after the one or more applications terminate.

15. The system of claim 1, wherein:
the lock menu application enables the user to configure the lock screen prior to displaying the lock menu.

16. The system of claim 1, wherein:
the lock menu application enables the user to set up a more special application that perform a specific function or run an application in a specific way.

17. The system of claim 1, wherein:
the lock menu application enables the user to set up an application which allows the user to go directly to the main desktop from the lock menu, bypassing the current run queue.

18. The system of claim 16, wherein:
the lock menu application enables the user to configure a set of contacts or numbers and then specify a special application icon/slider to go to display this list in order to provide the user with access to frequently dialed numbers.

19. The system of claim 1, wherein:
the lock menu is displayed after a security screen is displayed.

20. The system of claim 19, wherein:
the security screen requires one of either a pin, password or a pattern.

21. A method for providing a user with deterministic control over a host device having a touch screen, comprising:
providing the user with a lock menu application that displays on the touch screen a lock menu of a plurality of applications that can be run on the host device when the user wakes up the host device;
enabling the user to select one or more of the plurality of applications from the menu by sliding a slider; and
running the selected one or more applications on the host device.

22. The method of claim 21, further comprising:
determining termination behavior of the selected one or more applications and
allowing the user to configure the options when the selected one or more applications terminate.

23. The method of claim 21, further comprising:
enabling the user to specify the plurality of applications on the menu.

24. The method of claim 21, further comprising:
enabling the user to select the one or more of the plurality of applications via a plurality of sliders.

25. The method of claim 21, further comprising:
enabling the user to select the one or more of a plurality of applications via icons in addition to the one or more sliders.

26. The method of claim 21, further comprising:
enabling the user to set the lock menu to take over the entire touch screen when the lock menu screen is displayed and eliminate the standard alert bar from being displayed on the lock menu.

27. The method of claim 21, further comprising:
enabling the user to turn off display of the lock menu on the touch screen.

28. The method of claim 21, further comprising:
enabling the user to configure number of the plurality of applications on the menu.

29. The method of claim 21, further comprising:
enabling the user to configure which application is running when the user unlocks the host device.

30. The method of claim 21, further comprising:
enabling the user to set one of the application on lock menu to a direct dial number.

31. The method of claim 21, further comprising:
enabling the user to select the application to run next after the one or more applications terminate.

32. The method of claim 21, further comprising:
enabling the user to configure to return to default screen display of the host device after the one or more applications terminate.

33. The method of claim 21, further comprising:
enabling the user to configure the lock screen prior to displaying the lock menu.

34. The method of claim 21, further comprising:
enabling the user to configure to set up a more special application that perform a specific function or run an application in a specific way.

35. The method of claim 21, further comprising:
enabling the user to configure to set up a special application which allows the user to go directly to the main desktop from the lock menu, bypassing the current run queue.

36. The method of claim 34, further comprising:
enabling the user to configure to configure a set of contacts or numbers and then specify a special application icon/slider to go to display this list in order to provide the user with access to frequently dialed numbers.

37. The method of claim 21, further comprising:
displaying a security screen prior to displaying the lock menu.

38. The method of claim 37, further comprising:
the security screen requires the user to enter one of either a pin, password or a pattern.

39. A non-transitory computer readable storage medium embodying a set of instructions that, when executed by a machine, causes the machine to:
provide the user with a lock menu application that displays on the touch screen a lock menu of a plurality of applications that can be run on the host device when the user wakes up the host device;
enable the user to select one or more of the plurality of applications from the menu; and
run the selected one or more applications on the host device.
